(19) United States
(12) Patent Application Publication
(10) Pub. No.: US 2014/0184930 A1
(43) Pub. Date: Jul. 3, 2014

(54) System and Method for Providing Power to a Television Accessory

(71) Applicant: Gregory John Haxton, Brea, CA (US)

(72) Inventor: Gregory John Haxton, Brea, CA (US)

(21) Appl. No.: 14/142,600

(22) Filed: Dec. 27, 2013

Related U.S. Application Data
(60) Provisional application No. 61/746,452, filed on Dec. 27, 2012.
(60) Provisional application No. 61/767,592, filed on Feb. 21, 2013.
(60) Provisional application No. 61/817,181, filed on Apr. 29, 2013.

(51) Int. Cl. H04N 5/64

(52) U.S. Cl. CPC H04N 5/64
USPC 348/843

(57) ABSTRACT

The present system advantageously provides a source of power for a television accessory mounted to the back of the television monitor, such that the accessory power cables remain substantially hidden behind the television. The system includes a television monitor, a television accessory mounted to the back of the television monitor, and an auxiliary power adaptor that is connected in-line with the appliance cable for the television, so that electrical current can be delivered to both the television and the television accessory, while substantially maintaining the accessory power cables within the outer perimeter of the television on the back side.

### RELATED APPLICATION DATA

This application claims the priority date of provisional application No. 61/746,452 filed on Dec. 27, 2012, provisional application No. 61/767,592 filed on Feb. 21, 2013, and provisional application No. 61/817,181, filed on Apr. 29, 2013.

### BACKGROUND OF THE INVENTION

1. Field

The present system and method relates to providing a power source to television accessories, and more particularly, to a system that provides power to television accessories which are mounted to the television.

2. Description of the Related Art

Audio and video television accessories have become smaller and more easily hidden from view. Thus, many users have been mounting the accessories behind the television. Further, it is common to mount non-CRT televisions, such as plasma, LED, or LCD, to the wall or on a table. Many users desire the appearance of a clean installation with few, if any, wires showing from the front of the television. With wall mounted televisions in particular, this is increasingly difficult due to the electrical outlet usually being located several feet below the bottom of the television. As a result, the user can often see two or more electrical cables extending down from the television, which is aesthetically unpleasing and may tempt children and pets to tamper with the hanging power cables.

Some users have hired professional installers to provide an additional wall outlet behind the television, with many of the remotely stored accessories (the cable box, etc.) having signal cables fished through the wall to emerge from behind the television. This is a costly and involved process, which many users will not undertake.

Thus, what is needed is a system to power accessories which are mounted behind the television, without those accessory power cords being visible from the front of the television. Further, a system to hide power cords is needed that does not involve the installation of new wall sockets or other major work within the walls.

### SUMMARY OF THE INVENTION

The present system advantageously provides a source of power for a television accessory mounted to the back of the television monitor, such that the accessory power cables remain substantially hidden behind the television. The system includes a television monitor, a television accessory mounted to the back of the television monitor, and an auxiliary power adaptor that is connected in-line with the appliance cable for the television, so that electrical current can be delivered to both the television and the television accessory, while substantially maintaining the accessory power cables within the outer perimeter of the television on the back side.

The television monitor has an appliance inlet electrically connecting the television monitor to an electrical utility socket through an appliance power cord. The appliance power cord has a plug for insertion into an electrical utility socket at the wall and a connector coupler normally configured to connect to the appliance inlet.

The television accessory is in audio and/or video communication with the television monitor through an audio-video cable. The television accessory has an accessory power cord with an accessory plug.

The auxiliary power adaptor has a housing with a first cable and a second cable extending from the housing. The first cable has a plug connector coupler. The second cable has an auxiliary connector coupler. The housing has an auxiliary socket in electrical connection with the plug connector coupler and the auxiliary connector coupler. The auxiliary power adaptor is attached to a back side of the television monitor.

The auxiliary connector coupler is coupled to the appliance inlet of the television monitor in place of the connector coupler of the of the power cord. The connector coupler is coupled to the plug connector coupler of the auxiliary power adaptor. The plug of the power cord is coupled to the electrical utility socket, with the auxiliary power adaptor bridging an electrical connection between the electrical utility socket and the appliance inlet of the television monitor. And the accessory plug of the television accessory is coupled to the auxiliary socket to provide electrical power to the television accessory.

As an option, a third cable may extend from the housing of the auxiliary power adaptor, with the auxiliary socket being located at a terminus of the third cable. Again optionally, the housing of the auxiliary power adaptor may further include a second auxiliary socket in electrical connection with the plug connector coupler, the auxiliary connector coupler, and the auxiliary socket.

Optionally, the television accessory may be a streaming media player, where the streaming media player is attached to the back side of the television monitor through a connector so that the accessory power cord is substantially hidden when viewing the television monitor from a front side. The connector may optionally be a hook and loop fastener or a double sided tape.

Optionally, the television accessory may be a speaker, where the speaker is positioned in close proximity with the television monitor so that the accessory power cord is substantially hidden when viewing the television monitor from a front side. As a further option, the television accessory may be mounted to the bottom of the television monitor.

The system may further include a second television accessory with a second accessory power cord and a second accessory plug extending from the second television accessory. The second accessory plug of the second television accessory is coupled to the second auxiliary socket to provide electrical power to the second television accessory.

A method for powering a television accessory is also provided. The method includes the steps of providing an auxiliary power adaptor as described above, mounting the television accessory to the television monitor, coupling a connector coupler of the appliance power cord to the plug connector coupler of the auxiliary power adaptor, coupling the auxiliary connector coupler to the appliance inlet of the television monitor, mounting the auxiliary power adaptor to the back side of the television monitor such that the auxiliary power adaptor is hidden from view when viewing the television monitor from the front side, coupling the accessory plug of the television accessory to the auxiliary socket of the auxiliary power adaptor such that the accessory plug is hidden from view when viewing the television monitor from the front side, coupling the plug of the appliance power cord to the electrical utility socket, and providing electrical power to the television monitor and the television accessory though the auxiliary power adaptor.

As an option, the auxiliary power adaptor may further include a second auxiliary socket in electrical connection with the plug connector coupler. The above method may further include the steps of providing a second television accessory, mounting the second television accessory to the television monitor, and coupling the second accessory plug of the second television accessory to the second auxiliary socket of the auxiliary power adaptor such that the second accessory plug is hidden from view when viewing the television monitor from the front side.

### BRIEF DESCRIPTION OF THE SEVERAL VIEWS OF THE DRAWINGS

FIG. 1 is a perspective view of the preferred embodiment of the present invention, showing the auxiliary power adaptor;

FIG. 2 is a plan view of the preferred embodiment of the present invention, showing auxiliary power adaptor attached to a television monitor; and

FIG. 3 is a schematic view of the preferred embodiment of the present invention, showing some of the compatible connectors.

### LISTING OF REFERENCE NUMERALS of FIRST-PREFERRED EMBODIMENT

auxiliary power adaptor 20

housing 22

auxiliary socket 24

first cable 26

plug connector coupler 28

second cable 30

auxiliary connector coupler 32

connector 34

second auxiliary socket 36

strain relief 38

television monitor 100

back side 102

appliance inlet 104

appliance power cord 106

connector coupler 108

plug 110

outer perimeter 112

audio and video input 114

audio output 116

television accessory 200

accessory power cord 202

accessory plug 206

second television accessory 208

second accessory power cord 210

second accessory plug 212

audio and video cable 214

audio cable 216

IEC320 C5 connector 300

IEC320 C6 plug connector 302

IEC320 C7 connector 304

IEC320 C8 plug connector 306

IEC320 C13 connector 308

IEC320 C14 plug connector 310

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

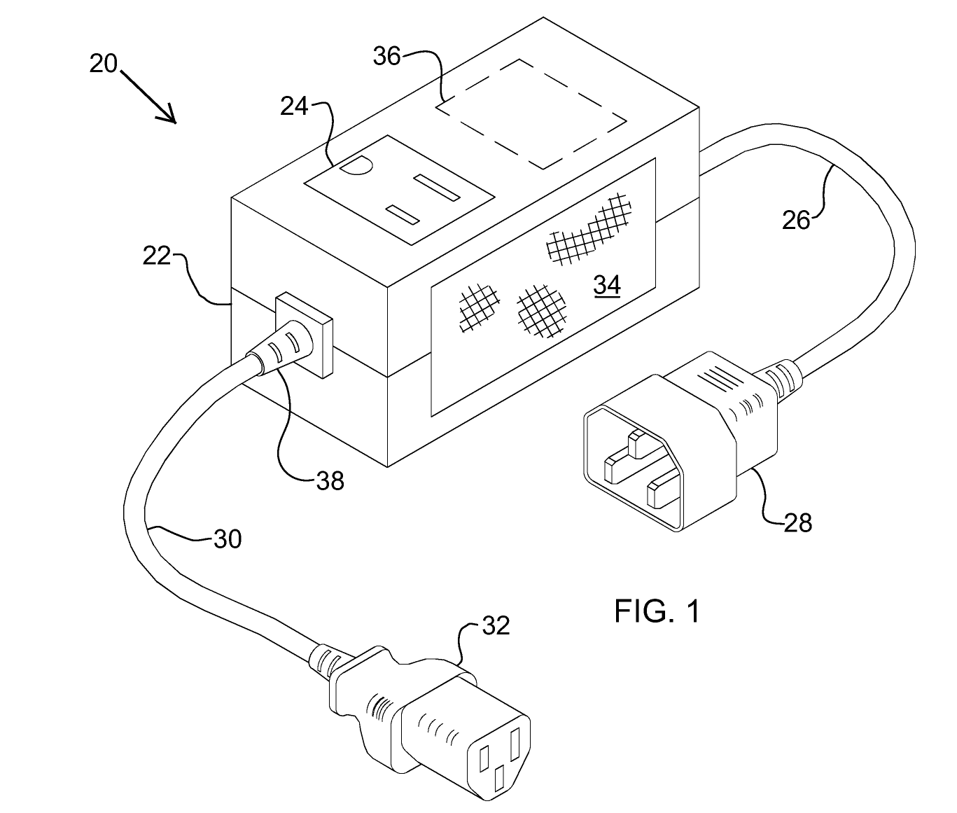

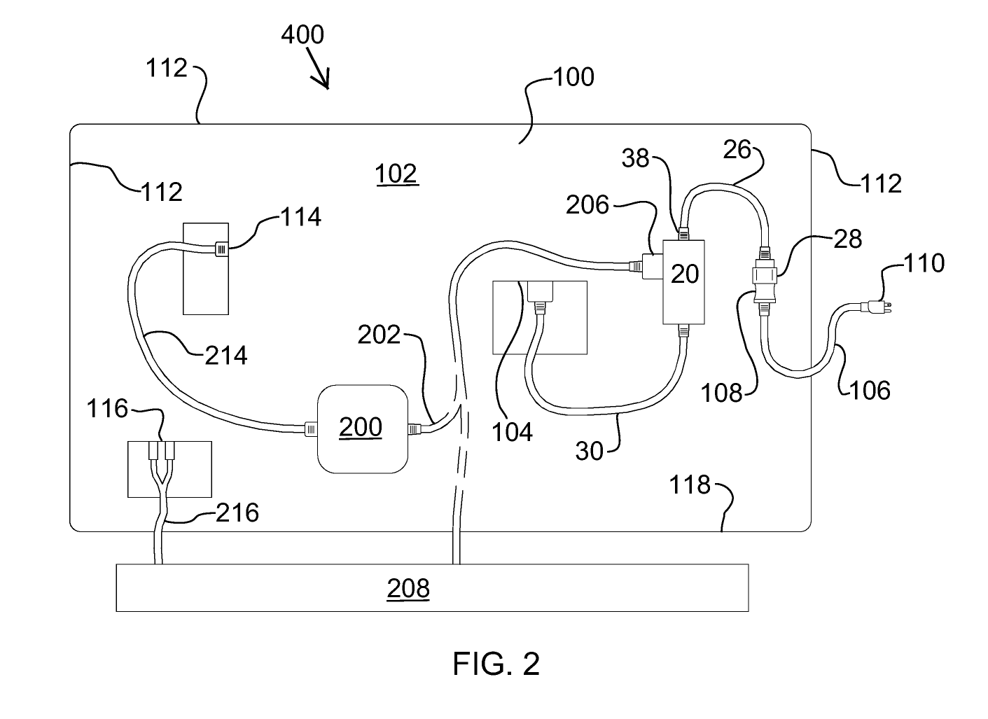

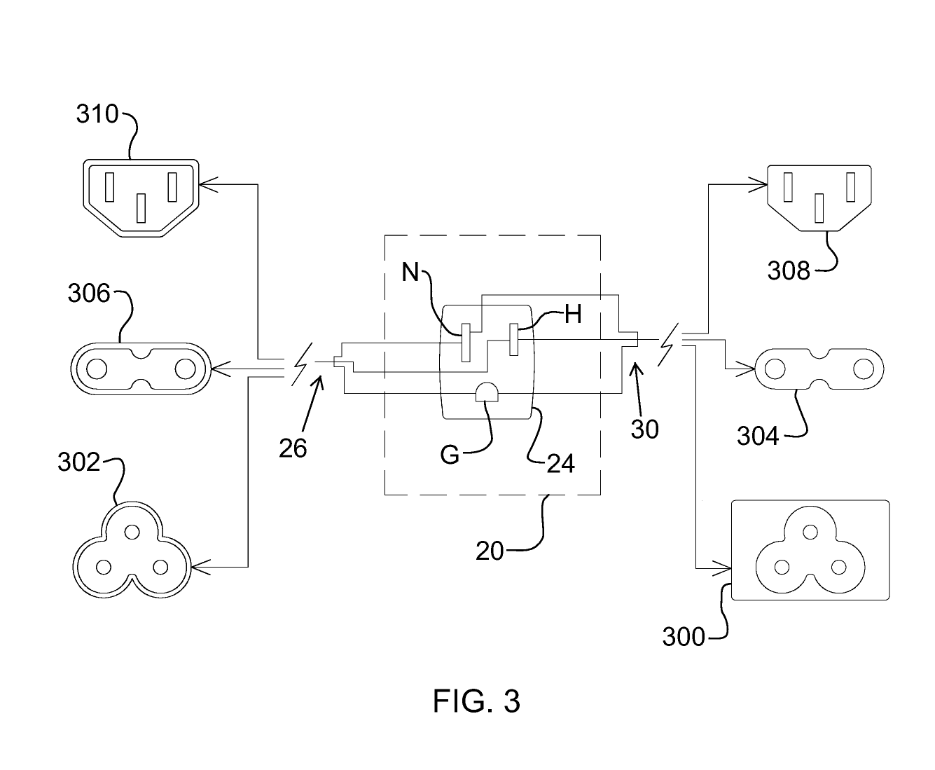

An exemplary embodiment of the present auxiliary power adaptor (20) can be seen in isolation in FIG. 1. In particular, this example includes a housing (22) within which the various electrical wires are connected to pass an electrical current though the auxiliary power adaptor (20) and split a portion of the electrical current for use by a television accessory (200), as will be described in greater detail in reference to FIGS. 2 and 3. a first cable (26) and a second cable (30) extend from the housing (22) and are each firmly held in connection with the housing though the strain relief (38). At the terminus of the first cable (26) is a plug connector coupler (28). And at the terminus of the second cable (30) is an auxiliary connector coupler (32).

Auxiliary, as used herein, relates to providing a secondary source of power to one or more television accessories (200) by splitting the power source to the television monitor. On at least one side of the housing (22), an auxiliary socket (24) is provided. The auxiliary socket (24) can be one of many standard sockets, which may depend on the country of use, on the particular outlets found in a house, or on the plug used with the television. In the illustrated example, the auxiliary socket (24) is a three-prong socket standardly identified as a NEMA 5-15R receptacle. However, a two-prong socket may be used, standardly identified as a NEMA 1-15R receptacle. Further, a second auxiliary socket (36) may be included on the housing (22).

Because the present auxiliary power adaptor (20) may be adapted to power two or more television accessories (200), which may have differing plugs, the auxiliary socket (24) may be a NEMA 5-15R receptacle and the second auxiliary socket (36) may be a NEMA 1-15R receptacle. Alternatively, both the auxiliary socket (24) and the second auxiliary socket (36) may be identical receptacles.

The housing (22) is preferably made of an insulating thermoplastic material, that may be injection molded in two shells, which when assembled, form the enclosure of the housing (22). An opening at each end of the housing (22) permits passage of the first cable (26) and the second cable (30) through the housing (22) wall, with a strain relief (38) preventing stress on internal wiring. An opening on one of the sides accommodates the installation of the auxiliary socket (24). Alternatively, the housing (22) can be can be injection molded around the internal wiring and auxiliary socket (24) in an overmold or similar process, sealing the internal wiring within the housing (22).

One side of the auxiliary power adaptor (20) is configured to mount to the back side (102) of the television monitor (100) through a connector (34). The connector (34) can be one of many means to connect a television accessory (200) to the back side (102), including a hook and loop fastener (as shown), double sided tape, a bracket that hold the television accessory (200) to the back side (102), or other similar connecting means. In one example, the loop side of the hook and loop fastener may be adhered to the auxiliary power adaptor (20) and the hook side may be adhered to the back side (102) of the television monitor (100), so that the user can mount the auxiliary power adaptor (20) to the back side (102).

As will be described in greater detail below, the auxiliary power adaptor (20) is configured to be mounted to the back side (102) of a television monitor (100). Since many modem media streaming devices may not require line of sight to remotely control the devices, many users have chosen to mount the media streaming devices to the back of the television or other hidden space. For example, an infrared (IR) controlled device may receive a signal from behind the television, without a direct line of sight between the device and the remote control, due to the IR signal bouncing off walls, etc. Some devices are controlled with radio frequency signals (RF), which may be hidden to a greater extent than the IR controlled devices. Yet other devices may have an IR “eye” connected to a cable, where the cable is connected to the streaming device and the eye is mounted to the front side of the television to permit direct line of sight control. Some examples of media streaming devices include the ROKU, APPLE TV, NETGEAR NEOTV, and other similar devices.

Speakers for modern televisions, also called sound bars, are generally located in close proximity of the television, usually being mounted to the bottom edge, to edge, or sitting on the television stand immediately below the television. The sound bar often requires a power source independent from the audio cable, such as an RCA cables. Thus, the sound bar is usually connected to an electrical utility socket to provide sufficient power.

Because the streaming media player and the sound bar both connect to one or both of an audio and video connectors on the back of the television, the user often mounts the box behind the television to hide many of the cables. Thus, there is a desire to also hide the power cables, so that they are not visible from the front of the television.

Looking now at FIG. 2, the present system (400) is shown fully assembled, as viewed from the back side (102) of the television monitor (100). The television monitor (100) is viewed in FIG. 2 from the back side (102), with the viewing screen or front side facing into the paper. The television monitor (100) has an outer perimeter (112) that defines a hidden area behind the television monitor (100) which is not normally visible to a user view the screen. The auxiliary power adaptor (20) is mounted to the back side (102) of the television monitor (100) by a connector (34). An appliance power cord (106) normally provides a direct electrical connection between the appliance inlet (104) and the electrical utility socket found on the wall. However, the connector coupler (108) of the appliance power cord (106) is disconnected from the appliance inlet (104), so that the auxiliary power adaptor (20) can be installed in-line. Particularly, the connector coupler (108) of the appliance power cord (106) is instead connected with the plug connector coupler (28) of the first cable (26). The auxiliary connector coupler (32) of the second cable (30) is connected to the appliance inlet (104) in place of the connector coupler (108), to complete an electrical connection between the electrical utility socket and the appliance inlet (104) through the auxiliary power adaptor (20).

The television accessory (200) is shown also mounted to the back side (102), in close proximity to the audio and video input (114), so that a short audio and video cable (214) may be used. Depending on the audio and video input (114) of the television monitor (100), the cable may be component video, HDMI, composite RCA, S-video, or the like. The accessory plug (206) of the accessory power cord (202) is connected to the auxiliary power adaptor (20) through the auxiliary socket (24), so that electrical current is provided to the television accessory (200). Optionally, a second television accessory (208) is mounted to the bottom edge (118) of the television monitor (100). In this example, a sound bar receives an audio signal through the audio cable (216) from the audio output (116). The sound bar is shown slightly separated from the bottom edge (118) of the television monitor (100), but may also be directly mounted to the bottom edge (118) or other portion of the television monitor (100).

In the illustrated example, the first and second television accessories (200, 208) are mounted to the television monitor (100) as alternate embodiments, with the cables represented in phantom showing two option mounting configurations. However, if the first and second television accessories (200, 208) are both mounted, the accessory power cord (202) would be connected to the auxiliary socket (24) and the second auxiliary power cord (210) would be connected to the second auxiliary socket (36).

The purpose of mounting the present auxiliary power adaptor (20) to the back side (102) is so that the accessory power cords (202, 210) are substantially hidden from view by substantially keeping the cables (202, 210) within the outer perimeter (112) and on the back side (102) of the television monitor (100). In this way, perhaps only one power cable, the appliance power cord (106) extends into the user's view to connect to the electrical utility socket below. Thus, the present system (400) hides most or all of the cables behind the television monitor (100) and within the outer perimeter (112).

An example embodiment of the present auxiliary power adaptor's (20) wiring is illustrated in FIG. 3. The auxiliary socket (24) is shown with the wires of the first cable (26) and the second cable (30) schematically represented. Further illustrated are several of the many possible connectors combinations available. The topmost connector combination is an IEC320 C14 plug connector (310) at the end of the first cable (26) and an IEC320 C13 connector (308) at the end of the second cable (30). The middle connector combination is an IEC320 C8 plug connector (306) at the end of the first cable (26) and an IEC320 C7 connector (304) at the end of the second cable (30). Finally, the bottommost connector combination is an IEC320 C6 plug connector (302) at the end of the first cable (26) and an IEC320 C5 connector (300) at the end of the second cable (30). The receptacles of the auxiliary socket are marked as neutral (N), hot (H), and ground (G).

As an alternate embodiment, a third cable (not shown) may extend from the housing (22) with the NEMA 5-15R auxiliary socket (24) fixed to the terminus of the third cable. Thus, instead of the auxiliary outlet (24) being flush-mounted within the housing (22), it is located at the end of the third cable.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A system for providing a source of power, the system comprising:
a television monitor with an appliance inlet electrically connecting the television monitor to an electrical utility socket through a power cord, the power cord having a plug for insertion into the electrical utility socket and a connector coupler normally for connection to the appliance inlet;
a television accessory in at least one of an audio signal and a video signal communication with the television monitor, the television accessory having an accessory power cord extending therefrom with an accessory plug; and
an auxiliary power adaptor, the auxiliary power adaptor having a housing with a first cable extending from the housing and a second cable extending from the housing, the first cable having a plug connector coupler, the second cable having an auxiliary connector coupler, the housing having an auxiliary socket in electrical connection with the plug connector coupler and the auxiliary connector coupler;
the auxiliary power adaptor being attached to a back side of the television monitor;
the auxiliary connector coupler being coupled to the appliance inlet of the television monitor in place of the connector coupler of the of the power cord;
the connector coupler being coupled to the plug connector coupler of the auxiliary power adaptor, the plug of the power cord being coupled to the electrical utility socket, the auxiliary power adaptor bridging an electrical connection between the electrical utility socket and the appliance inlet of the television monitor; and
the accessory plug of the television accessory being coupled to the auxiliary socket to provide electrical power to the television accessory.

2. The system of claim 1 wherein the television accessory is a streaming media player, the streaming media player being attached to the back side of the television monitor through a connector so that the accessory power cord is substantially hidden when viewing the television monitor from a front side.

3. The system of claim 2 wherein the connector is one of a hook and loop fastener and a double sided tape.

4. The system of claim 1 wherein the television accessory is a speaker, the speaker being positioned in close proximity with the television monitor so that the accessory power cord is substantially hidden when viewing the television monitor from a front side.

5. The system of claim 1 wherein the television accessory is mounted to a bottom of the television monitor.

6. The system of claim 1 wherein a third cable extends from the housing of the auxiliary power adaptor, the auxiliary socket being located at a terminus of the third cable.

7. The system of claim 1 wherein the housing of the auxiliary power adaptor further including a second auxiliary socket in electrical connection with the plug connector coupler, the auxiliary connector coupler, and the auxiliary socket.

8. The system of claim 7 wherein the system further includes a second television accessory with a second accessory power cord with a second accessory plug extending from the second television accessory, the second accessory plug of the second television accessory being coupled to the second auxiliary socket to provide electrical power to the second television accessory.

9. The system of claim 8 wherein the television accessory is a streaming media player and the second television accessory is a speaker.

10. A method for powering a television accessory, the method comprising the steps of:
providing an auxiliary power adaptor, the auxiliary power adaptor having a housing with a first cable extending from the housing and a second cable extending from the housing, the first cable having a plug connector coupler, the second cable having an auxiliary connector coupler, the housing having an auxiliary socket in electrical connection with the plug connector coupler and the auxiliary connector coupler;
mounting the television accessory to a television monitor;
coupling a connector coupler of an appliance power cord to the plug connector coupler of the auxiliary power adaptor;
coupling the auxiliary connector coupler to an appliance inlet of the television monitor;
mounting the auxiliary power adaptor to the back side of the television monitor such that the auxiliary power adaptor is hidden from view when viewing the television monitor from a front side;
coupling an accessory plug of the television accessory to the auxiliary socket of the auxiliary power adaptor such that the accessory plug is hidden from view when viewing the television monitor from the front side;
coupling the plug of the appliance power cord to the electrical utility socket; and
providing electrical power to the television monitor and the television accessory though the auxiliary power adaptor.

11. The method of claim 10, wherein the auxiliary power adaptor further comprises a second auxiliary socket in electrical connection with the plug connector coupler, the auxiliary connector coupler, and the auxiliary socket, the method further comprising the steps of:
providing a second television accessory;
mounting the second television accessory to the television monitor; and
coupling a second accessory plug of the second television accessory to the second auxiliary socket of the auxiliary power adaptor such that the second accessory plug is hidden from view when viewing the television monitor from the front side.

11. The method of claim 10, wherein the television accessory is a streaming media player and the second television accessory is a speaker.
